(19) United States
(12) Patent Application Publication
(10) Pub. No.: US 2001/0009421 A1
(43) Pub. Date: Jul. 26, 2001

(54) Display control system, display control method therefor, and display apparatus

(76) Inventor: Toshihisa Nakano, Nara (JP)

Correspondence Address: David G. Conlin, Dike, Bronstein, Roberts & Cushman, Intl. Prop. Practice Group, Edwards & Angell, LLP, 130 Water Street, Boston, MA, 02109, US

(21) Appl. No.: 09/769,911

(22) Filed: Jan. 25, 2001

(30) Foreign Application Priority Data
Jan. 25, 2000 (JP) 2000-016351
Nov. 6, 2000 (JP) 2000-338402

(51) Int. Cl. G09G 5/00

(52) U.S. Cl. 345/643

(57) ABSTRACT

A display control system includes: a display control apparatus including command data transmission means for transmitting command data; and a display apparatus for performing display based on command data transmitted from the command data transmission means, it wherein the display apparatus includes: command data receiving means for receiving the command data; command data interpretation means for applying a mathematical operation to the received command data so as to generate image data; and display means for displaying an image in accordance with the image data.

### BACKGROUND OF THE INVENTION

1. Field of the Invention

The present invention relates to a display control system, a display control method therefor, and a display apparatus.

2. Description of the Related Art

Referring to FIG. 1, an example of a conventional display control system (a computer system) will be described.

The conventional computer system shown in FIG. 1 includes a computer 10 and a display apparatus 30, which are interconnected via a connection cable 20. The computer 10 includes a mathematical operation processor 11, a memory 12, an input device 13 (e.g., a keyboard and/or a mouse), and a graphics controller 15. The elements 11, 12, 13, and 15 are connected to a bus 14 used for transferring data between these elements. The mathematical operation processor 11 generates command data in accordance with a request received from the input device 13, and transfers a generated draw command data to the graphics controller 15 via the bus 14. The graphics controller 15 applies mathematical operations to the draw command data received from the mathematical operation processor 11 to generate image data. The graphics controller 15 also utilizes a frame buffer 16 coupled thereto to transfer the generated image data to the display apparatus 30 via the connection cable 20. The display apparatus 30 displays the received image data on a display 38.

Hereinafter, operation of the conventional computer system shown In FIG. 1 will be described in more detail with respect to a case where a figure is to be drawn on the display 38 of the display apparatus 30. First, the mathematical operation processor 11 receives is a request from a user via the input device 13 to draw a figure. Next, the mathematical operation processor 11 generates draw command data concerning the shape, positioning, color, etc., of the figure to be drawn, and transfers the draw command data to the graphics controller 15. The graphics controller 15 subjects the draw command data to mathematical operations (e.g., interpretation and/or processing of draw commands) to generate image data. The generated image data is stored in the frame buffer 16. The graphics controller 15 sequentially retrieves the image data from the frame buffer 16 and transfers all image data corresponding to one frame to the display apparatus 30. The display apparatus 30 displays the received image data on the display 38. Thus, the figure requested by the user is drawn on the display.

As described above, in a conventional display control system, image data which has been subjected to mathematical operations by the computer (display control apparatus) 10 is transferred to the display apparatus 30 to display an image. Specifically, image data which has been subjected to mathematical operations by the graphics controller 15 within the computer 10 is transferred to the display apparatus 30. Thus, since all image data corresponding to one frame as obtained through the mathematical operations performed by the graphics controller 15 is to be transferred, the amount of data transferred from the display control apparatus 10 to the display apparatus 30 is extremely large, as is well known in the art.

Methods for transferring image data from the display control apparatus 10 to the display apparatus 30 are generally classified into analog transfer methods and digital transfer methods. In the case of implementing a wired transfer, image data transferred by an analog transfer method is susceptible to degradation associated with poor quality of the connection cable 20 used to connect the display control apparatus 10 with the display apparatus 30, as well as influence of external noise, etc. Thus, the image data which is output from the display control apparatus may be distorted, which causes blurring, noise, and other forms of degradation in the quality of the images displayed on the display apparatus 30.

On the other hand, in the case where image data is transferred by a digital transfer method, a large number of transfer cables or a high transfer rate must be used in order to enable transfer of a large amount of data. For example, in the case of a display apparatus having a resolution of 1600×RGB×1200 dots, a transfer rate of 495 Mbit/sec is required to transfer such a large amount of data. In fact, no device is currently available which is capable of transferring data at a data rate necessary for transmitting image data to a display apparatus having an even greater resolution, for example, of 2048×RGB×1536 dots, 2560×RGB×2048 dots, or 3200×RGB×2400 dots. In implementations where a plurality of currently available devices are combined to together realize the required transfer rate, an increased number of transfer cables must again be used. Also, there are other constraints on the transfer rate which are associated with transfer ability parameters, such as cable capacity and/or propagation lag.

In the case of implementing wireless transfer as a means for transferring image data from the display control apparatus 10 to the display apparatus 30, expensive wireless equipment will be required for either an analog transfer method or a digital transfer to enable transfer of a large amount of data.

The rationale for outputting image data, although resulting in a large quantity, from a computer to a display apparatus has been as follows.

The world-wide standard architecture for current computers in general are based on the IBM PC architecture, which was initially marketed by International Business Machines (IBM) Corporation, U.S.A., in 1981. When joining the computer market, IBM adopted an uninhibited “open” strategy of laying open to the industry a BIOS program (which governs a basic portion of the machine structure of an IBM PC computer), bus specifications, and the like. This open strategy enabled third-party companies to easily produce their own extension cards, etc., to IBM PC computers, which led to the wide prevalence of the IBM PC architecture. IBM PC computers originally incorporate a monochrome display adaptor called an MDA, which features a general-purpose CRT controller designated MC6845. A character generator is provided within a BIOS-ROM. The generated characters are programmed to be transferred to a video RAM, and further transferred therefrom (as image data) via a CRT controller, to an external display apparatus such a CRT display. Thus, all image-related processing is performed within BIOS.

Thereafter, any new extension cards for image-related purposes are designed as an extension on the basis of the aforementioned CRT controller. These facts, also combined with a need to ensure downward compatibility with older-generation models, explain the rationale for outputting image data from a computer to a display apparatus, although thereby resulting in a large quantity of data.

In the terminology used to described the present invention, a “graphics controller” corresponds to an extension of the aforementioned CRT controller, and a “frame buffer” corresponds to the aforementioned video RAM.

### SUMMARY OF THE INVENTION

According to one aspect of the present invention, there is provided a display control system including: a display control apparatus including command data transmission means for transmitting command data; and a display apparatus for performing display based on command data transmitted from the command data transmission means, wherein the display apparatus includes: command data receiving means for receiving the command data; command data interpretation means for applying a mathematical operation to the received command data so as to generate image data; and display means for displaying an image in accordance with the image data.

In one embodiment of the invention, the command data interpretation means also serves as the command data receiving means.

In another embodiment of the invention, the command data interpretation means generates the image data based on data which is received via the command data receiving means.

In still another embodiment of the invention, the command data transmission means and the command data receiving means are coupled via a transfer cable.

In still another embodiment of the invention, the command data transmission means and the command data receiving means are coupled via wireless means.

In still another embodiment of the invention, the command data contains draw command data.

In still another embodiment of the invention, the command data contains at least one of error check information and error correction information.

In still another embodiment of the invention, the command data is encrypted.

According to another aspect of the present invention, there is provided a display control method for a display control system including a display control apparatus including command data transmission means for transmitting command data and a display apparatus for performing display based on command data transmitted from the command data transmission means, wherein the method comprises the steps of: transferring command data from the display control apparatus to the display apparatus; applying a mathematical operation to the transferred command data in the display apparatus to generate image data; and displaying an image in accordance with the image data.

According to yet another aspect of the present invention, there is provided a display apparatus for performing display based on command data transmitted from outside of the display apparatus, including: command data interpretation means for applying a mathematical operation to command data so as to generate image data; and display means for displaying an image in accordance with the image data.

In one embodiment of the invention, the command data interpretation means also serves as the command data receiving means.

In another embodiment of the invention, the command data interpretation means generates the image data based on data which is received via the command data receiving means.

Thus, the invention described herein makes possible the advantages of: (1) providing a display control system; (2) providing a display control method therefor; and (3) providing a display apparatus, such that only a small amount of data is required to be transferred from a display control apparatus to the display apparatus.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating a structure of a conventional display control system.

FIG. 2 is a block diagram illustrating a structure of a display control system according to the present invention.

FIG. 3 is a block diagram illustrating a structure of another display control system according to the present invention.

FIG. 4 is a data format diagram illustrating a format of draw command data in the case of drawing a circle according to the present invention, the draw command data being transferred by a digital transfer method.

FIG. 5 is a data format diagram illustrating a format of draw command data in the case of drawing a square according to the present invention, the draw command data being transferred by a digital transfer method.

### DESCRIPTION OF THE PREFERRED EMBODIMENTS

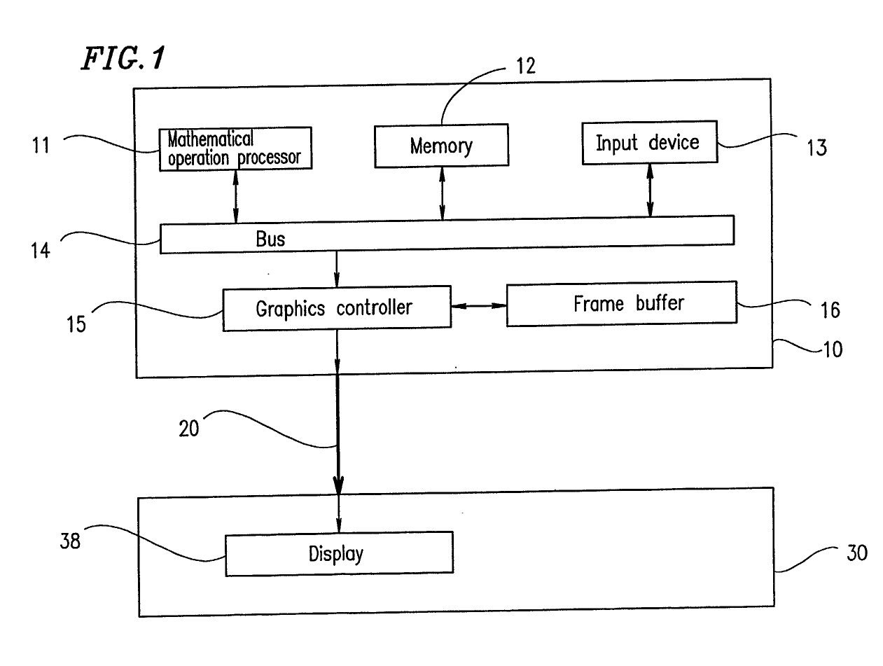

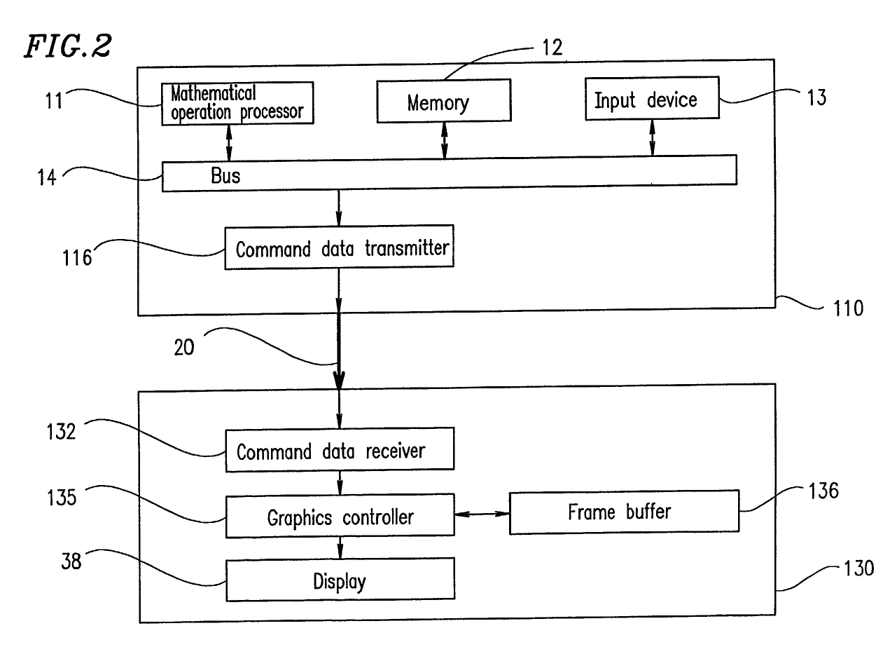

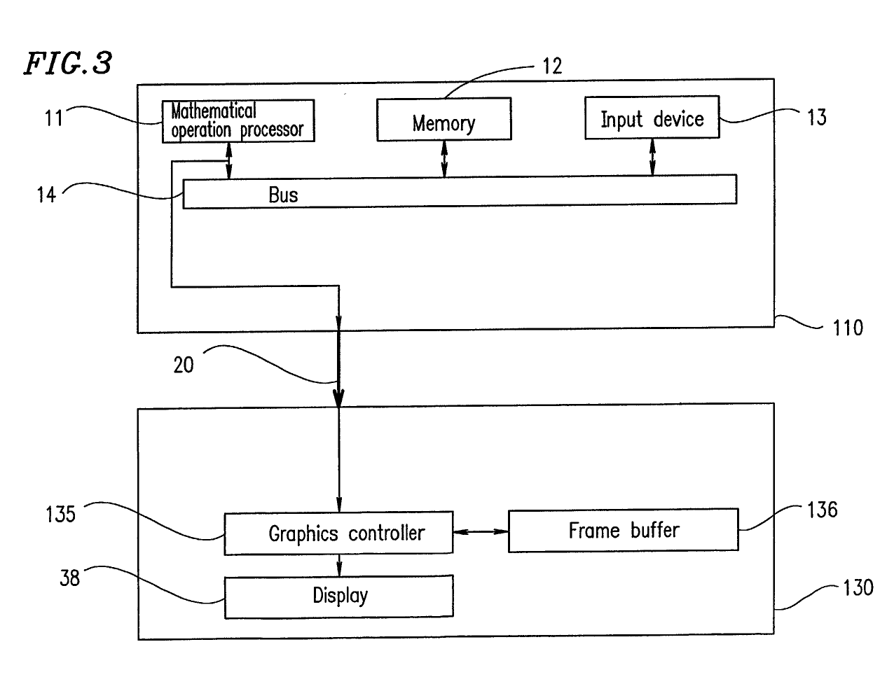

Hereinafter, specific embodiments of a display control system, a display control method therefor, and a display apparatus according to the present invention will be described with reference to FIGS. 2 and 3. FIGS. 2 and 3 each schematically illustrates a display control system (computer system) according to an embodiment of the present invention. In FIGS. 2 and 3, the constituent elements which correspond to the constituent elements of the conventional display control system shown in FIG. 1 are denoted by the same numerals as those used therein.

The display control system shown in FIG. 2 includes a computer (display control apparatus) 110 and a display apparatus 130, which are interconnected via a connection cable 20. The display control apparatus 110 includes a mathematical operation processor 11, a memory 12, an input device 13 (e.g., a keyboard and/or a mouse), and a command data transmitter (“command data transmission means” or “command data transmission section”) 116. The elements 11, 12, 13, and 116 are connected to a bus 14 used for transferring data between these elements. The mathematical operation processor 11 generates command data in accordance with a request received from the input device 13, and transfers the generated command data to the command data transmitter 116 via the bus 14. The command data transmitter 116 transmits the received command data to the display apparatus 130 via the connection cable 20. The memory 12 may be any data storage means, such as a hard disk or a RAM.

The display apparatus 130 includes a command data receiver (“command data receiving means” or “command data receiving section”) 132 for receiving command data from the command data transmitter 116, a graphics controller (“command data interpretation means” or “command data interpretation section”) 135; a frame buffer 136, and a display (“display means” or “display section”) 38. The command data receiver 132 receives command data from the command data transmitter 116 and inputs the received command data to the graphics controller 135. The graphics controller 135 subjects the command data to mathematical operations (e.g., interpretation and/or processing of the command data) to generate image data. The generated image data is stored in the frame buffer 136. The graphics controller 135 sequentially retrieves the image data from the frame buffer 136 and inputs image data to the display 38, which performs display.

Hereinafter, operation of the display control system according to the present invention shown in FIG. 2 will be described with respect to a case where a figure is to be drawn on the display 38.

First, the mathematical operation processor 11 receives a request from a user via the input device 13 to draw a figure. Next, the mathematical operation processor 11 generates draw command data concerning the shape, positioning, color, etc., of the figure to be drawn, and transfers the draw command data to the display apparatus 130 via the command data transmitter 116. The draw command data only contains information concerning instructions for controlling display, and therefore has a very small data size.

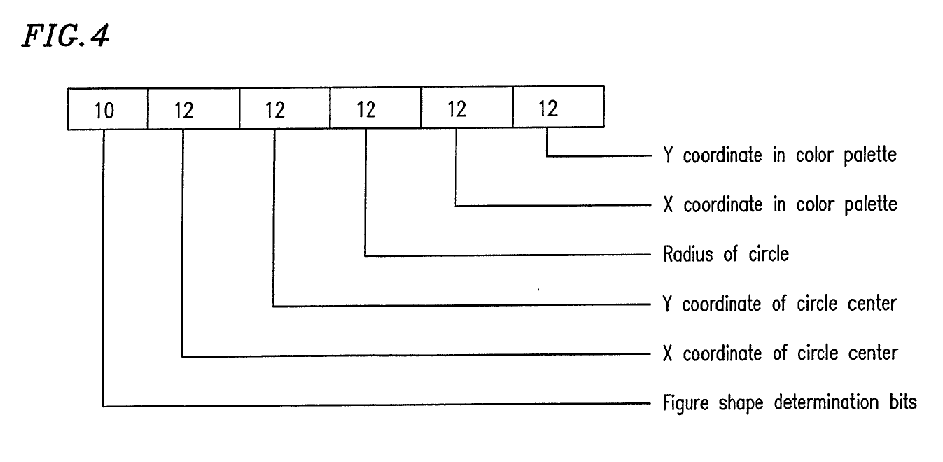

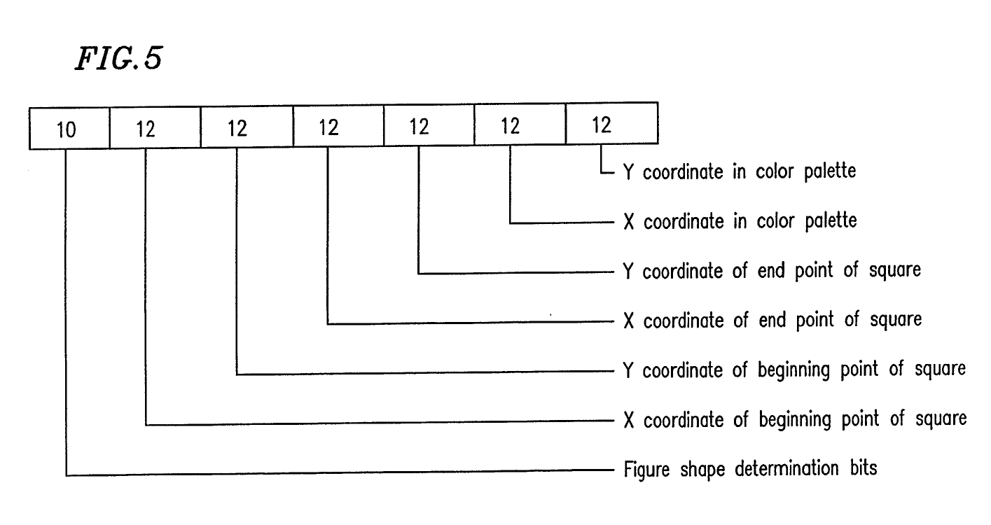

FIGS. 4 and 5 each show an exemplary format of draw command data, where the draw command data is to be transferred by a digital transfer method. FIG. 4 illustrates draw command data for drawing a circle. The first 10 bits are figure shape determination bits. In the case where the first 10 bits indicate a circle, as in FIG. 4, the next 12 bits represent an X coordinate of the center of the circle; the next 12 bits represent a Y coordinate of the center of the circle; the next 12 bits represent the radius of the circle; the next 12 bits represent an X coordinate in a color pallet of the system; and the next 12 bits represent a Y coordinate in the color pallet of the system.

FIG. 5 illustrates draw command data for drawing a square. The first 10 bits (i.e., figure shape determination bits) indicate a square. The next 12 bits represent an X coordinate of a beginning point of the square; and the next 12 bits represent a Y coordinate of the beginning point of the square. The next 12 bits represent an X coordinate of an end point of the square; and the next 12 bits represent a Y coordinate of the end point of the square. Furthermore, the next 12 bits represent an X coordinate in a color pallet of the system; and the next 12 bits represent a Y coordinate in the color pallet of the system.

When transferring the draw command data to the display apparatus 130, error check information or error correction information may be added to the draw command data in order to enable verification of whether or not the draw command data is properly transferred. In this case, the draw command data and the error check information or error correction information together compose the command data to be transferred from the command data transmitter 116. Moreover, when transferring the draw command data to the display apparatus 130, the command data may be transferred in an encrypted form for improved security.

In the case where the data transferred via the connection cable 20 represents a still image having a resolution of 1600×RGB×1200 dots (note that a still image does not require redrawing), a transfer rate of 495 Mbit/sec would have conventionally been required. On the other hand, according to the present invention, in the case where only a circle is to be displayed, only a single transfer of 70 bit data as exemplified in FIG. 4 is required, irrespective of the size, positioning, or color of the circle to be displayed.

Once the draw command data is transferred to the display apparatus 130, the graphics controller 135 in the display apparatus 130 subjects the command data to mathematical operations (e.g., interpretation and/or processing of the command data) to generate image data, including the shape, positioning, color, etc., of the figure to be displayed. By displaying the image data on the display 38 utilizing the frame buffer 136, a figure as desired by the user can be rendered.

Although the transfer of command data between the display control apparatus 110 and the display apparatus 130 is realized via the command data transmitter 116 and the command data receiver 132 in the exemplary structure illustrated in FIG. 2, the graphics controller 135 may directly receive command data from the mathematical operation processor 11. In this case, the mathematical operation processor 11 also serves as a command data transmission means, and the graphics controller 135 also serves as a command data receiving means.

With respect to the command data transmission means provided within the display control apparatus 110 and the command data receiving means provided within the display apparatus 130, the present invention is not limited to the particular structures illustrated in FIGS. 2 and 3. For example, the mathematical operation processor 11 in the display control apparatus 110 may also serve as a command data transmission means, and the display apparatus 130 may include the command data receiver 132. Alternatively, the display control apparatus 110 may include the command data transmitter 116, and the graphics controller 135 in the display apparatus 130 may also serve as a command data receiving means.

Although the computer (display control apparatus) 110 is illustrated on the transmitting end of the data transfer according to the above-described embodiments of present invention, the device on the transmitting end in the display apparatus and the display control system according to the present invention is not limited to a computer. The effects of reducing a data amount to be transferred from the transmitting end device can be obtained regardless of the type of transmitting end device.

Although the display control apparatus 110 and the display apparatus 130 are illustrated as being connected via the connection cable 20 in the above description, the present invention is not limited to such a configuration. Alternatively, the display control apparatus 110 and the display apparatus 130 may be connected via wireless means; that is, the transfer of command data from the display control apparatus 110 to the display apparatus 130 may be achieved via a wireless device.

According to the present invention, the command data interpretation means (graphics controller) 135 for subjecting draw command data to mathematical operations for obtaining image data is provided in the display apparatus 130. As a result, the amount of data to be transferred to the display apparatus 130 from outside of the display apparatus 130 can be reduced. For example, in the case where data is to be transferred from a display control apparatus to the display apparatus 130, the amount of data to be transferred can be substantially reduced as compared to that required in conventional systems.

Since command data is transferred instead of image data, image distortion is eliminated in the case of a wired transfer. Since a reduced amount of data is transferred, it is possible to employ a reduced number of transfer cables, or to employ a low data transfer rate. On the other hand, in the case where command data is transferred by wireless means, it is possible to employ a relatively inexpensive wireless device because only a small amount of data needs to be transferred.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A display control system comprising:
a display control apparatus including a command data transmission section for transmitting command data; and
a display apparatus for performing display based on command data transmitted from the command data transmission section,
wherein the display apparatus includes:
a command data receiving section for receiving the command data;
a command data interpretation section for applying a mathematical operation to the received command data so as to generate image data; and
a display section for displaying an image in accordance with the image data.

2. A display control system according to claim 1, wherein the command data interpretation section also serves as the command data receiving section.

3. A display control system according to claim 1, wherein the command data interpretation section generates the image data based on data which is received via the command data receiving section.

4. A display control system according to claim 1, wherein the command data transmission section and the command data receiving section are coupled via a transfer cable.

5. A display control system according to claim 1, wherein the command data transmission section and the command data receiving section are coupled via a wireless device.

6. A display control system according to claim 1, wherein the command data contains draw command data.

7. A display control system according to claim 1, wherein the command data contains at least one of error check information and error correction information.

8. A display control system according to claim 1, wherein the command data is encrypted.

9. A display control method for a display control system including a display control apparatus including a command data transmission section for transmitting command data and a display apparatus for performing display based on command data transmitted from the command data transmission section,
wherein the method comprises the steps of:
transferring command data from the display control apparatus to the display apparatus;
applying a mathematical operation to the transferred command data in the display apparatus to generate image data; and
displaying an image in accordance with the image data.

10. A display apparatus for performing display based on command data transmitted from outside of the display apparatus, comprising:
a command data interpretation section for applying a mathematical operation to command data so as to generate image data; and
a display section for displaying an image in accordance with the image data.

11. A display apparatus according to claim 10, wherein the command data interpretation section also serves as the command data receiving section.

12. A display apparatus according to claim 10, wherein the command data interpretation section generates the image data based on data which is received via the command data receiving section.
